(19) United States
(12) Patent Application Publication
(10) Pub. No.: US 2009/0280374 A2
(43) Pub. Date: Nov. 12, 2009

(54) PROCESS FOR SEALING PLATES IN A FUEL CELL

(75) Inventors: PETER ANDRIN, NAPANEE, ONTARIO (CA); KALYAN GHOSH, KINGSTON, ONTARIO (CA); BISWAJIT CHOUDHURY, WILMINGTON, DE (US); PHIL BATES, INVERARY, ONTARIO (CA); HELMUT WIELAND, KINGSTON, ONTARIO (CA); IYOBOSA EKHATOR, BROCKVILLE, ONTARIO (CA)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, UNITED STATES, 302-992-2973, 302-992-4773, PTO-Legal.PRC@usa.dupont.com

(73) Assignee: E. I. DU PONT DE NEMOURS AND COMPANY, Wilmington, DE (US)

(21) Appl. No.: 10/550,424

(22) Filed: Oct. 24, 2005

Related U.S. Application Data
(60) Provisional application No. 60/457,459, filed on Mar. 25, 2003.

(51) Int. Cl. H01M 2/08; H01M 10/04; H01M 10/50; H01M 8/04

(52) U.S. Cl. 429/26; 29/623.2; 29/623.4; 429/120; 429/185

(57) ABSTRACT

There is provided a process for sealing a coolant plate to an adjacent bi-polar plate or coolant plate in an electrochemical cell. The first coolant plate comprises at least one mating region for mating with a complementary region on the adjacent plate, the adjacent plate is a second coolant plate or a bipolar plate of the electrochemical cell, and the first coolant plate and the adjacent plate each comprise a polymer and conductive filler. The process comprises the step of welding the mating region to the complementary region to create a seal formed by the polymer at the mating region and the complementary region. Welding may be done using resistance welding or vibration welding processes.

### FIELD OF THE INVENTION

The present invention relates to a process for sealing plates in an electrochemical cell, and in particular to a process for sealing two coolant plates together or a coolant plate to a bipolar plate using heat lamination, vibration welding or resistive welding techniques.

### BACKGROUND OF THE INVENTION

Electrochemical cells, and in particular fuel cells, have great future potential. Polymer electrolyte membrane fuel cells (PEMFC) comprise a membrane electrode assembly (MEA) disposed between two separator plates commonly known as bi-polar plates. Within the MEA lies a pair of fluid distribution layers, commonly referred to as gas diffusion layers (GDL) and an ion exchange membrane. At least a portion of either the ion exchange membrane or gas diffusion layers is coated with noble metal catalysts. The ion exchange membrane is placed between the GDL and compressed to form the MEA. The bi-polar plates provide support to the MEA and act as a barrier, preventing mixing of fuel and oxidant within adjacent fuel cells. The bi-polar plates also act as current collectors. The bi-polar plates may include flow field channels that assist with transport of liquids and gases within the fuel cell.

A fuel cell stack functions as a series of connected fuel cells. The fuel cell stack produces a substantial amount of heat in addition to producing electricity through the reaction of fuel and oxidant. Heat must be removed from the fuel cell stack in order to operate the fuel cell stack isothermally. As a result, separator plates that assist with the transport of coolant fluid to and from the fuel cell (“coolant plates”) are used. The coolant plates may include flow field channels, grooves or passageways that are used to transport coolant within the fuel cell stack to remove excess heat and maintain the fuel cell stack at a suitable operating temperature. The coolant plates keep the coolant fluid separated from the bi-polar plates.

A fuel cell stack is generally provided with holes, commonly known as manifold holes, to transport reactants, products, and coolant to and from the fuel cell stack. The bi-polar plates and the coolant plates of the fuel cell stack are each connected by at least one channel to the inlet and outlet manifold holes. Through these channels, the bi-polar plates transport reactants and products to and from the GDL of the MEA, and the channels of the coolant plates transport coolant fluid.

As a result of the transfer of liquids and gas to and from the fuel cells within the fuel cell stack, proper sealing at the outer perimeter or periphery of channels and manifold holes, which contain liquids and gas, is important. In general, the bi-polar plates and the coolant plates are provided with seals to prevent the liquid or gases from leaking and to prevent inter-mixing of gases (fuel and oxidant) and coolant in the manifold areas. Gaskets are applied along the periphery of the bi-polar and coolant plates and along the periphery of the manifold holes and are fixed to the bi-polar plates or GDL using a suitable adhesive as described in U.S. Pat. No. 6,338,492 B1 and EP 0665984 B1, which are both hereby incorporated by reference. The gaskets may also be formed in the channels or grooves provided on the bi-polar plate, coolant plate, or GDL.

The most common type of sealant used in solid polymer electrolyte fuel cells are gaskets made of silicone rubber, RTV, E-RTV, or like materials. Gaskets of this type are disclosed in WO 02/093672 A2, U.S. Pat. No. 6,337,120 and U.S. Patent Application Nos. 20020064703, 20010055708 and 20020068797, which are hereby incorporated by reference.

There are several disadvantages associated with using sealant materials such as silicone rubber, RTV, E-RTV to seal the periphery and manifold areas of the bi-polar plates and coolant plates. Firstly, the sealant material may not be compatible with the plate material used, which may be graphite, graphite composites or metals. Secondly, commonly used sealant materials degrade over time with fuel cell operation. As a result, the sealing action of the gasket is eventually diminished, leading to inter-mixing of gases and liquid. Moreover, it is often difficult to correctly position the gaskets in the grooves or channels provided on the bi-polar plates, coolant plates, or GDLs using conventional manufacturing methods.

Application of any gasket material as sealant between a coolant plate and another coolant plate or bipolar plate often leads to the loss in conductivity between these two joined plates. Being insulators, most of these gasket materials are designed to minimize the loss of conductivity, which often leads to the use of thin gasket material, however, a drawback is that thin gasket materials are vulnerable to mechanical failure under high stress fuel cell operational conditions. Significant research work is underway to determine a compromise between the gasket thickness and conductivity loss to achieve desired fuel cell longevity and durability.

WO 02/091506 discloses a flow field plate having a plurality of protrusions to join the flow field plate to an adjacent flow field plate. The plates may be welded together around their periphery using ultrasonic welding.

There, therefore, remains a need to provide an improved process for creating seals for bi-polar or coolant plates that reduces the disadvantages associated with conventional sealing techniques.

The disclosures of all patents/applications referenced herein are incorporated herein by reference.

### SUMMARY OF THE INVENTION

The present invention provides a process for sealing a plate such as a coolant plate to either an adjacent coolant plate or an adjacent bi-polar plate without using any external gasket or sealant. The sealing of the plates is accomplished using heat lamination, vibration welding or resistive welding techniques.

According to one aspect of the invention there is provided a process for sealing a first coolant plate of an electrochemical cell with an adjacent plate, wherein the first coolant plate comprises at least one mating region for mating with a complementary region on the adjacent plate, wherein the adjacent plate is a second coolant plate or a bipolar plate of the electrochemical cell, and the first coolant plate and the adjacent plate each comprise a polymer and conductive filler, said process comprises the step of welding said mating region to said complementary region to create a seal formed by the polymer at the mating region and the complementary region.

In one embodiment of the invention, welding is achieved by resistance welding. In another embodiment of the invention, welding is achieved by vibrational welding.

The preferred embodiments of the present invention can provide many advantages. For example, the use of external seal materials for joining coolant plates may be eliminated. As no external material is used for the seal, there is no problem of material compatibility during sealing and long-term degradation issues are eliminated. The sealed plates can also tolerate higher operating pressures and temperatures. The seal is comprised of the same material as the coolant plate or bi-polar plate, therefore, there is no contamination expected from the seal. The method is cheaper and faster compared to the other conventional sealing processes. The seal can be made immediately after the plate molding process without handling any adhesive or glue-like materials to form the seal on the plates.

Numerous other objectives, advantages and features of the process will also become apparent to the person skilled in the art upon reading the detailed description of the preferred embodiments, the examples and the claims.

### BRIEF DESCRIPTION OF THE DRAWINGS

The preferred embodiments of the present invention will be described with reference to the accompanying drawings in which like numerals refer to the same parts in the several views and in which:

FIG. 1a is an exploded perspective view of the membrane electrode assembly;

FIG. 1b is an exploded perspective view of a typical polymer electrolyte membrane fuel cell of the prior art, which shows the use of a sealing gasket to prevent leakage from the coolant plates;

FIG. 2 is a top view of a coolant plate showing flow field channels;

FIGS. 3a to 3d are schematic drawings of coolant plates and bi-polar plates made in accordance with a preferred embodiment of the invention;

FIG. 4 is a schematic drawing of a seal created between the coolant plates and bi-polar plates of FIG. 3a; and

FIGS. 5a and 5b are plots of contact resistance versus compression pressure.

### DETAILED DESCRIPTION OF THE PREFERRED EMBODIMENTS

The preferred embodiments of the present invention will now be described with reference to the accompanying figures.

One aspect of the present invention provides a process for sealing a coolant plate and another coolant plate or bipolar plate. The seal is created without using additional sealant materials such as silicone rubber, RTV, E-RTV, glue etc.

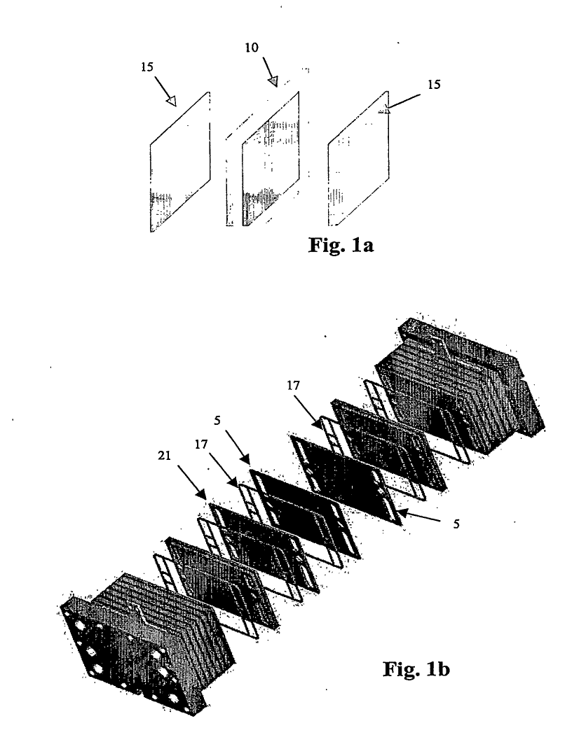

As shown in FIG. 1a, a typical polymer electrolyte membrane fuel cell comprises a MEA disposed between two bipolar plates 5. The MEA includes an ion exchange membrane 10 and two gas diffusion layers (GDL) 15. A sealing gasket 17 is adhered between the bi-polar plate 5 and GDL 15 to prevent leakage of fluids from the central part of the MEA, known as the active area (FIG. 1b).

The bipolar plate 5 comprises at least one gas flow field with a channel and landing to allow gas or liquid to flow to and from the fuel cell. The bipolar plates 5 are typically bi-polar in construction and may carry either fuel or oxidant on any side of the bi-polar plate 5 depending on the design of the electrochemical cell or electrochemical cell stack.

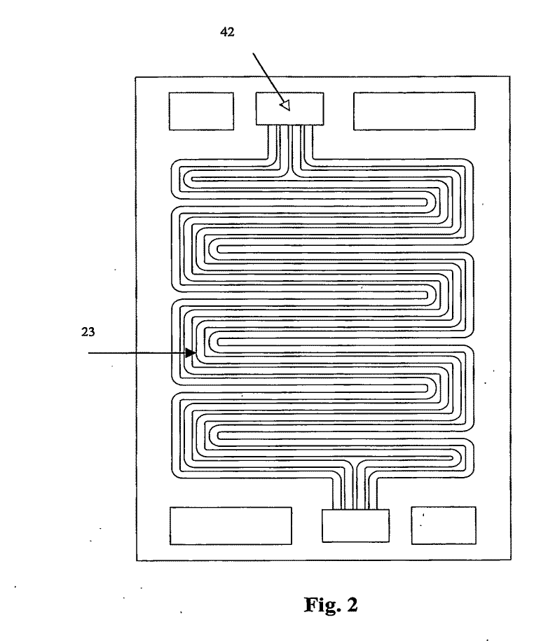

To remove excess heat produced in the electrochemical cell in the stack, coolant plates 21 are included in the stack. Coolant plates 21 may be used in various places within the electrochemical cell stack depending on the design of the electrochemical cell stack. Typically, coolant plates 21 are located adjacent the bi-polar plates 5 as shown in FIG. 1b. As shown in FIG. 2, the coolant plate 21 possesses manifold holes 42 and flow field channels 23 on either one side or both sides of the coolant plate. These flow field channels 23 allow coolant fluid to flow to and from the electrochemical cell. A sealing gasket 17 is located between the coolant plates 21 and bi-polar plates 5 to prevent leakage of coolant fluid (see FIG. 1b).

The bi-polar plates 5 and coolant plates 21 are generally moulded from a composition comprising a polymer resin binder and conductive filler, with the conductive filler being preferably graphite fibre and graphite powder. The polymer can be any thermoplastic polymer or any other polymer having characteristics similar to a thermoplastic polymer. The thermoplastic polymers can include melt processible polymers, such as Teflon® FEP and Teflon® PFA, partially fluorinated polymers such as PVDF, Kynar®, Kynar Flex®, Tefzel®, thermoplastic elastomers such as Kalrez®, Viton®, Hytrel®, liquid crystalline polymer such as Zenite®, polyolefins such as Sclair®, polyamides such as Zytel®, aromatic condensation polymers such as polyaryl(ether ketone), polyaryl(ether ether ketone), and mixtures thereof. Most preferably, the polymer is a liquid crystalline polymer resin such as that available from E.I. du Pont de Nemours and Company under the trademark ZENITE®. A blend of 1 wt % to 30 wt %, more preferably 5 wt % to 25 wt % of maleic anhydride modified polymer with any of the above-mentioned thermoplastic polymers, partially fluorinated polymers and liquid crystalline polymer resin and their mixture can also be used as binding polymer.

The graphite fiber is preferably a pitch-based graphite fiber having a fiber length distribution range from 15 to 500 μm, a fiber diameter of 8 to 15 μm, bulk density of 0.3 to 0.5 g/cm³ and a real density of 2.0 to 2.2 g/cm³. The graphite powder is preferably a synthetic graphite powder with a particle size distribution range of 20 to 1500 μm, a surface area of 2 to 3 m²/g, bulk density of 0.5 to 0.7 g/cm³ and real density of 2.0 to 2.2 g/cm³. Further detail regarding the composition of the bi-polar plates 5 and cooling plates 21 are described in U.S. Pat. No. 6,379,795 B1, which is herein incorporated by reference.

In a preferred embodiment of the present invention, the coolant plates 21 and bi-polar plates 5 are molded from a composition as described in co-pending of PCT patent application no. PCT/CA03/00202 filed Feb. 13, 2003, the complete specification of which is hereby incorporated by reference. The composition includes from about 1 to about 50% by weight of the polymer, from about 0 to about 70% by weight of a graphite fibre filler having fibres with a length of from about 15 to about 500 microns, and from 0 to about 99% by weight of a graphite powder filler having a particle size of from about 20 to about 1500 microns. Preferably, the composition comprises:
a. from about 1 wt % to about 50 wt % of ZENITE® 800 aromatic polyester resin;
b. from about 0 wt % to about 70 wt % of pitch-based graphite fiber (fiber length distribution range: 15 to 500 micrometre; fiber diameter: 8 to 10 micrometre; bulk density: 0.3 to 0.5 g/cm³; and real density: 2.0-2.2 g/cm³); and
c. from about 0 wt % to about 99 wt % graphite powder (particle size distribution range: 20 to 1500 micrometre; surface area: 2-3 m²/g; real density: 2.2 g/cm³).

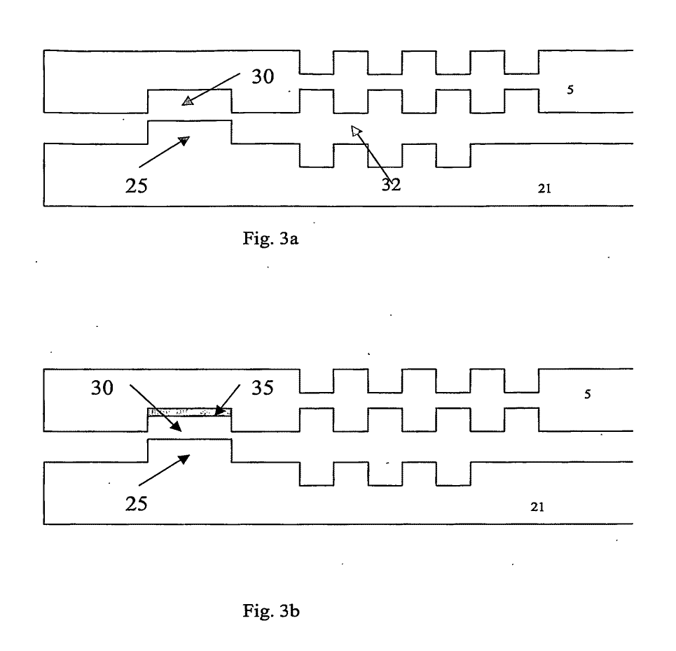

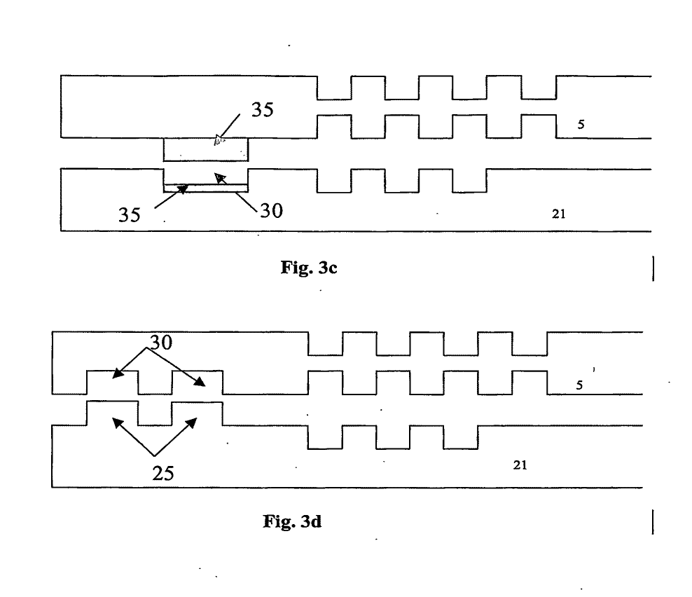

The preferred embodiment of the present invention provides a process for permanently sealing one coolant plate 21 to another coolant plate or to a bipolar plate, where the seals are located at the periphery of the plates and/or around the manifold holes 42. The coolant plate 21 is sealed at its periphery to an adjacent coolant plate 21 or to an adjacent bi-polar plate 5. Sealing is facilitated by the configuration of the coolant plates 21 and bi-polar plates 5. As shown in FIGS. 3a to 3d, the bi-polar plates 5 and the coolant plates 21 are configured with at least one mating region on one plate for mating with a complementary region on the other plate. Preferably, the mating region is in the form of ribs 25 and the complementary region is in the form of grooves 30. The mating ribs 25 or grooves 30 may be formed on either the bi-polar plate 5 or the coolant plate 21 depending on the particular fuel cell design. The dimensions of the mating ribs 25 and grooves 30 also vary according to the fuel cell design. The width and height of the mating ribs 25 and grooves 30 are preferably from 0.01 mm to 10 mm, and 0.1 mm to 15 mm, respectively, more preferably from 1.0 mm to 2.0 mm and 1.1 mm to 1.9 mm respectively. In addition, there could be more than one mating rib 25 or groove 30 on each of the bi-polar plate 5 or coolant plate 21.

To create the permanent seal at the periphery of the coolant plate 21, the ribs 25 of the coolant plate 21 or bi-polar plate 5 are welded to the complementary grooves 30 of the adjacent coolant plate 21 or bi-polar plate 5 using suitable welding techniques such as resistance welding and vibration welding. However, other techniques such as ultrasonic welding, laser welding, heat lamination, or hot bonding techniques may also be used for joining the ribs 25 to the grooves 30.

With the vibration welding technique, a vibrational welding machine is used to create a vibrational force amongst and between the coolant plates 21 and bi-polar plates 5 bringing the coolant plates 21 and bi-polar plates 5 together and placing the mating ribs 25 and grooves 30 within close proximity of each other. The vibrational force can be applied to both the bi-polar plate 5 and coolant plate 21, or either one of the plates while keeping the other plate stationary.

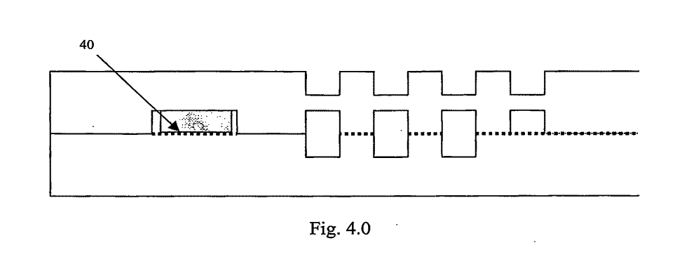

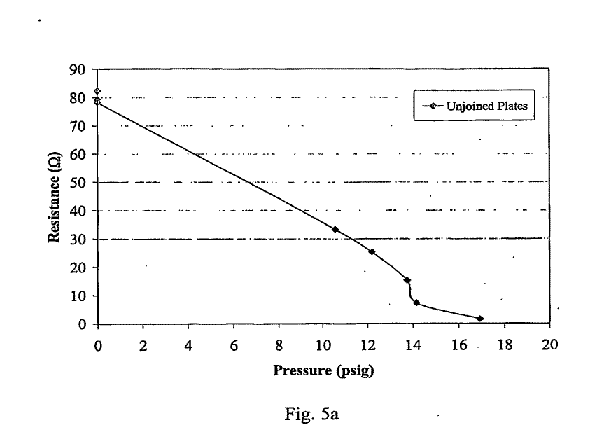

The continued vibrational force on the coolant plates 21 and bipolar plates 5 causes the contact area between the mating ribs 25 and grooves 30 to become frictionally engaged, resulting in the production of localized heat which melts the polymer component present in the composite material at the ribs 25 and grooves 30 of the coolant plate 21 and bi-polar plate 5. When the vibrational force is reduced or is stopped, localized heat production is diminished or eliminated and the coolant plate 21 and bi-polar plate 5 are cooled, solidifying the localized molten polymer composition and fusing the area between the coolant plate 21 and bi-polar plate 5. Pressure is preferably applied to the coolant plate 21 and bi-polar plate 5 during cooling to fuse the molten polymer composition of the coolant plate 21 and bi-polar plate 5 together, creating a permanent seal 40 between the coolant plate 21 and bi-polar plate 5 (see FIG. 4). The preferred pressure applied is between about 10 and about 200 psig.

The ribs 25 and grooves 30 of the bi-polar plates 5 and coolant plates 21 are configured so that during vibration welding of the bi-polar plate 5 and cooling plate 21 only the ribs 25 are in contact with the grooves 30, while the rest of the plates are not in contact, for example, by leaving a gap between the central areas (usually the flow field channels) 32 of the bi-polar plate 5 and the coolant plate 21. As shown in FIG. 4, this configuration allows the polymer component in the ribs 25 to melt during vibration, bringing the central portions (usually the flow field channels) of the bi-polar plates 5 and cooling plates 21 in contact with each other to minimize the resistive loss between the individual electrochemical cell units in the electrochemical cell stack.

The amplitude, frequency and application time of the vibrational force applied to the bi-polar plate 5 and coolant plate 21 determines the extent to which the ribs 25 and grooves 30 will fuse with each other and form a permanent seal. In a preferred embodiment, the vibrational welding process spans about 3 to about 100 seconds, at a frequency of about 100 to about 500 cycles per second and an amplitude of about 0.5 mm to about 5 mm. It will be apparent to a person skilled in the art that the amplitude, frequency and vibrational timing of the vibrational welding process is designed to complement the sealing action of the polymers within the ribs 25 and grooves 30 and to create minimum contact loss between the bi-polar plates 5 and cooling plates 21.

The quality of sealing created by the vibrational welding method can further be improved by providing a polymer rich material or pure polymer layer 35 to the ribs 25 or grooves 30 of the bi-polar plates or cooling plates (FIGS. 3b and 3c). The bi-polar plate 5 or coolant plate 21 may therefore be polymer rich at a localized area 35 (see FIGS. 3b and 3c). In a preferred embodiment, the localized area 35 is 0.002″ to 0.100″ thick and more preferably 0.020″ thick. This localized area 35 comprises between about 25 wt % and about 100 wt % polymer, preferably between about 50 wt % and about 100 wt % polymer, and most preferably about 100 wt % polymer.

The vibrational welding method may also be used to create a seal at the periphery of the manifold holes 42 of the coolant plates 21 and bipolar plates 5. While the process remains the same as described above, the coolant plates 21 and bipolar plates 5 will be designed in a manner that provides ribs 25 and complementary grooves 30 around the periphery of the manifold holes 42.

Resistive welding may also be used to create the seals between two coolant plates or between a coolant plate and a bipolar plate. The general process for resistance welding is set out in U.S. Pat. No. 4,673,450 to Burke, which is hereby incorporated by reference However, its application to the fabrication of integrated electrochemical cell components for fuel cell or electrolyzer applications has not yet been explored.

With the resistance welding process, an alternating or direct current is used to create seals between the ribs 25 and grooves 30 of the bi-polar plate 5 and coolant plate 21. An electrical current is passed between the coolant plate 21 and bi-polar plate 5 after the bi-polar plate 5 and coolant plate 21 are brought together so that the mating ribs 25 and grooves 30 are in contact with each other for sealing. Some pressure may also be applied to the coolant plate 21 and bi-polar plate 5 at the outset to keep the coolant plate 21 and bi-polar plate 5 together.

As current flows through the bi-polar plate 5 and coolant plate 21, the contact area between the mating ribs 25 and grooves 30 experiences relatively higher resistance, thereby resulting in the production of localized heat at the ribs 25 and grooves 30. This localized heat melts the polymer component at the ribs 25 and grooves 30. At this point, the flow of current is stopped while pressure is applied to the bi-polar plate 5 and coolant plate 21 to fuse the melted portion of the bi-polar plate 5 and coolant plate 21 together. Localized heat production stops when the current is withdrawn and the temperature of the bi-polar plate 5 and coolant plate 21 at the ribs 25 and grooves 30 drops quickly to a temperature below the glass transition temperature of the polymer. As a result, the fused area between the bi-polar plate and coolant plate is solidified creating a permanent seal 40 (see FIG. 4) resulting in an integrated electroconductive electrochemical cell component.

The bi-polar plate 5 and coolant plate 21 can be designed so that they act as electrodes to supply current directly, thereby eliminating the need for separate electrodes for applying current during the resistive welding process.

The ribs 25 and grooves 30 of the bi-polar plates 5 and coolant plates 21 are configured so that during the flow of current through the bi-polar plate 5 and coolant plate 21 only the ribs 25 and grooves 30 are in contact, leaving a gap between the rest of the plates, especially in the central area (usually the flow field channels) of the bi-polar plate 5 and the coolant plate 21. This configuration allows the extra height of the ribs 25 to melt during current flow thus bringing the central portions (usually the flow field channels) of the bi-polar plates 5 and cooling plates 21 in contact with each other to minimize the resistive loss of individual components of the electrochemical cell stack.

The magnitude of the alternating current and applied pressure and the duration of the current flow are chosen according to the desired sealing quality between the ribs 25 and grooves 30. These parameters also depend on the surface area and surface morphology of the sealing area of the plate. The amperage, voltage, design pressure and span of current flow will vary depending on the welding surface area and the degree of melting desired at the ribs 25 and grooves 30. However, in a preferred embodiment, the applied current is between about 0.1 amperes/mm² and about 5 amperes/mm², preferably between about 0.8 and about 1.1 amperes/mm² and its voltage is about 5 to about 25 volts, and the resistance welding process spans about 0.1 to about 100 seconds. The applied pressure is preferably between about 50 and about 1000 psig, more preferably between 100 psig and 300 psig, depending on the configuration of the plate.

The resistance welding process may also be used to create seals between ribs 25 and grooves 30 around the periphery of the manifold holes 42 of the coolant plates 21 and/or bipolar plates 5. While the process remains the same as described above, the coolant plates 21 and bipolar plates 5 will be designed in a manner that allows sealing around the periphery of the manifold holes 42.

It will be apparent to one skilled in the art that the electroconductive electrochemical cell components provided by the present invention have many applications. They can be used in any types of fulel cell and/or electrolyzer applications. The fabrication process can be used to join a bi-polar plate 5 and coolant plate 21 to form a seal around the external periphery or around the manifold holes 42 of a the coolant plate 21. The vibration welding and resistance welding processes can also be used to form a seal around the periphery and manifold areas of the metal plates used for electrochemical cell, such as PEMFC stacks. It is also not limited to PEMFC fuel cell stacks, but can also be extended to direct methanol fuel cells (DMFC), water electrolyzer and phosphoric acid fuel cells where heat needs to be dissipated using a coolant flow field plate.

The following examples illustrate the various advantages of the preferred method of the present invention.

### EXAMPLES

### Example 1

### Vibration Welding

Two manufactured composite plates, comprising 25% Zenite®-800, 55% Thermocarb® graphite powder and 20% graphite fibre were joined together using vibration welding method. The parts have a length of 60.9 mm, width of 17.5 mm and a thickness of 3.4 mm.

The parts were welded together using a Branson Mini II vibrational welding machine. The parts were heated to 160° C. and then placed in the vibrational welding machine, which had been preset at 1.78 mm amplitude, 1.5 mm melt down and 1.0 MPa pressure. The parts were welded at both Butt and T positions. The strength of the welded joint was measured and tabulated in Table 1.

TABLE 1
Weld Strength Measurements

| Weld Strength Test | Strength of Weld (MPa) |
|---|---|
| T-weld strength | 1.69 |
| Jason max strength | 31.21 |
| Jason average strength | 25.30 |
| Jason minimum strength | 20.59 |

### Example 2

### Resistance Welding

Two composite plates comprising 25% Zenite® 800, 55% Thermocarb® graphite powder and 20% graphite fibre were welded and joined together using the resistance welding process. The plates had a length of 60.9 mm, a width of 17.5 mm and a thickness of 3.4 mm in size.

A jig was made to apply a direct current through two electrodes attached directly to each plate. A welding machine was used as a power source. The jig also applied and controlled the pressure on the composite plates. A gas cylinder was used as the source of pressure.

The two composite plates were placed in the jig (for Butt welding position) and an 80-ampere (80 A) current was passed through the parts for approximately 2.52 seconds. 2 psig pressure was applied to the plates during the melt down process (Test Parts 1).

The weld strength of the welded joint was measured and compared with other samples in which the current, pressure or time of welding was changed. When the welding time was reduced to 1.91 seconds, the weld strength increased to 4.01 MPa (Test Parts 2). In another experiment, an increase in weld strength to 6.78 MPa was observed when current flow was reduced from 80 A to 70 A but the weld time increased to 4.03 seconds (Test Parts 3). A possible reason for the increase in weld strength is that there may be less polymer degradation at lower weld current—at higher current (80 A), the polymer likely degrades faster than at the lower current (70 A). The weld strength of Test Parts 4 was also measured using 90 A current for 4.25 seconds. Table 2 provides a comparison of the weld strength test using the various parameters.

TABLE 2
Summary of Weld Strength Results Using Resistance

| | Test | Test | Test | Test |
|---|---|---|---|---|
| Test Parameters | Parts 1 | Parts 2 | Parts 3 | Parts 4 |
| Current (A) | 80 | 80 | 70 | 90 |
| Pressure (psig) | 2 | 2 | 2 | 3.5 |
| Maximum Weld Time (sec) | 2.52 | 1.91 | 4.03 | 4.25 |
| Meltdown (mm) | 1.84 | 1.84 | 1.84 | 1.45 |
| Maximum weld strength, MPa | 1.12 | 4.01 | 6.78 | 3.42 |

### Example 3

### Resistance Welding

Two conductive composite plates, composed of the constituents similar to the one described in example-2, were joined together using resistive welding process. Both the plates had a length of 61 mm, a width of 61 mm and a thickness of 4 mm in size. The first plate possessed 1 mm wide and 1.5 mm high rib around the periphery of the plate. The second plate had a flat and smooth surface. A small hole with a radius of 2.5 mm was made in the centre of the first plate to conduct the pressure burst test with the joined plates. Alternatively, the second plate could have a 1 mm wide and 1.5 mm high rib around the periphery that corresponds to the rib of the first plate, or the second plate could have a 1.2 mm wide by 1.2 mm deep groove around the periphery of the plate that is complementary to the rib on the first plate.

Both plates were resistive welded together in a way similar to that described in example 2. The quality of joining was determined by measuring the meltdown of the height of the rib present in the periphery of the first plate. After joining, the integrated unit was subjected to a pressure burst test to evaluate the weld strength of the joined plate components, which can be used safely in the electrochemical cell, without any leakage of the reactant/product fluids or coolant fluid. The burst pressure shows the amount of gaseous pressure the joined component can withstand before the joined plates separate. Table 3 provides a comparison of the burst pressure with the meltdown of the joining rib of the plate.

TABLE 3
Summary of Weld Strength Results Using Resistance

| Sample Number | Meltdown (mm) | Burst Pressure (MPa) |
|---|---|---|
| 1 | 0.56 | 9 |
| 2 | 0.59 | 11 |
| 3 | 0.63 | 15 |
| 4 | 0.68 | 38 |
| 5 | 0.71 | 42 |
| 6 | 0.72 | 44 |

### Example 4

### Resistance Welding

Two composite plates comprising 25% Zenite® 800, 55% Thermocarb® graphite powder and 20% graphite fibre were welded and joined together using the resistance welding process. The plates had a length of 8.5 mm, a width of 8.5 mm and a thickness of 3.4 mm.

A jig was used to apply a direct current through two electrodes connected directly to each plate. A welding machine was used as a power source. The jig also applied and controlled the pressure on the composite plates. A gas cylinder was used as the source of pressure.

The two composite plates were placed in the jig and a 70-ampere (70 A) current was passed through the plates for approximately 1.5 seconds. A pressure of 8 psig was applied to the plates during the melt down process.

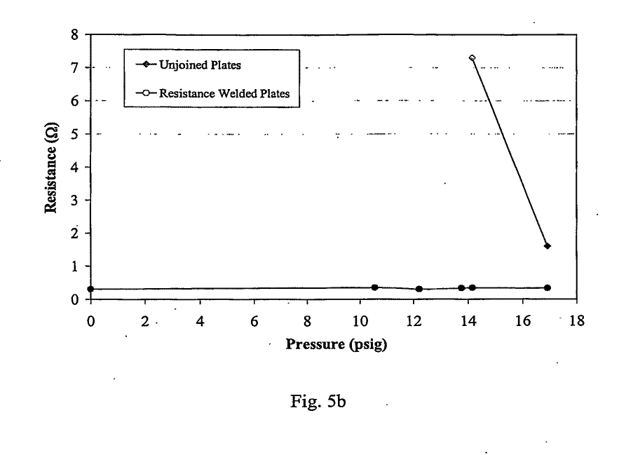

Prior to joining of the two plates, the contact resistance between both plates was measured under different compression pressures. The results are illustrated in FIG. 5a. After joining the plates using resistance welding method, the resistance of the joined plates was measured and plotted (FIG. 5b). It was found that the contact resistance of the joined plates was reduced significantly compared to the two plates that were not joined together, and the contact resistance was independent of the compression pressure applied between the plates.

Although the present invention has been shown and described with respect to its preferred embodiments and in the examples, it will be understood by those skilled in the art that other changes, modifications, additions and omissions may be made without departing from the substance and the scope of the present invention as defined by the attached claims.

What is claimed is:

1. A process for sealing a first coolant plate of an electrochemical cell with an adjacent plate, wherein the first coolant plate comprises at least one mating region for mating with a complementary region on the adjacent plate, wherein the adjacent plate is a second coolant plate or a bipolar plate of the electrochemical cell, and the first coolant plate and the adjacent plate each comprise a polymer and conductive filler, said process comprises the step of welding said mating region to said complementary region to create a seal formed by the polymer at the mating region and the complementary region.

2. The process of claim 1, wherein the welding step is selected from the group consisting of resistance welding, vibrational welding, ultrasonic welding, laser welding, heat lamination, and hot bonding techniques.

3. The process of claim 2, wherein the welding step is resistance welding.

4. The process of claim 3, wherein the resistance welding step comprises the further steps of:
(a) placing the mating region and complementary region in close proximity to each other;
(b) applying an electrical current between the first coolant plate and the adjacent plate to produce localized heat at the mating region and complementary region sufficient to melt the polymer at the mating region and complementary region; and
(c) ceasing to apply the current and applying pressure to the first coolant plate and the adjacent plate to allow the melted polymer to cool and to create a seal at the mating region and complementary region.

5. The process of claim 4, wherein the electrical current is between about 0.1 amperes/mm² and about 5 amperes/mm², preferably between about 0.8 and about 1.1 amperes/mm², its voltage is between about 5 and about 25 volts and the current is applied for a time from about 0.1 to about 100 seconds.

6. The process of claims 4 or 5 wherein the pressure applied is between about 1 and about 1000 psig, more preferably between 100 psig and 300 psig.

7. The process of any one of claims 4 to 6 wherein the electrical current is applied using either external electrodes or the plates themselves.

8. The process of claim 2, wherein the welding step is vibration welding.

9. The process of claim 8, wherein the vibration welding step comprises the further steps of:
(a) placing the mating region and complementary region in close proximity to each other;
(b) applying a vibrational force between the first coolant plate and the adjacent plate to produce localized heat at the mating region and complementary region sufficient to melt the polymer at the mating region and complementary region; and
(c) ceasing to apply the vibrational force and applying pressure to the first coolant plate and the adjacent plate to allow the melted polymer to cool and to create a seal at the mating region and complementary region.

10. The process of claim 9, wherein the vibrational force is applied at a frequency of between about 100 and about 500 cycles per second for a time from about 3 to about 100 seconds at an amplitude of between about 0.5 and about 5 mm.

11. The process of claims 9 or 10, wherein the pressure applied is between about 1 and about 1000 psig, more preferably between 100 psig and 300 psig.

12. The process of any one of claims 1 to 11, wherein the polymer is a thermoplastic polymer selected from the group consisting of melt processible polymers, partially fluorinated polymers, thermoplastic elastomers, liquid crystalline polymers, polyolefins, polyamides, aromatic condensation polymers, liquid crystalline polymers and mixtures thereof.

13. The process of claim 12, wherein the polymer is a blend of about 1 wt % to about 30 wt %, preferably about 5 wt % to about 25 wt %, of maleic anhydride modified polymers with the thermoplastic polymer, partially fluorinated polymers and liquid crystalline polymer or mixtures thereof.

14. The process of any one of claims 1 to 13, wherein the conductive filler is graphite fiber or graphite powder.

15. The process of any one of claims 1 to 14, wherein the mating region comprises a first rib and the complementary region comprises a second rib or a groove.

16. The process of claim 15, wherein at least one of the first coolant plate and the adjacent plate comprise a polymer rich outer layer on either the mating region, the complementary region or both.

17. The process of claim 16, wherein the polymer rich outer layer comprises between about 25 wt % and about 100 wt % polymer, preferably between about 50 wt % and about 100 wt % polymer, and most preferably about 100 wt % polymer.

18. The process of any one of claims 1 to 17, wherein the mating region and the complementary region are located adjacent to the periphery of the first coolant plate and the adjacent plate.

19. The process of any one of claims 1 to 17, wherein the first coolant plate and the adjacent plate each comprise at least one manifold hole and the mating region and the complementary region are at the periphery of the manifold holes.

20. The process of any one of claims 1 to 19, wherein the first coolant plate and the adjacent plate each comprise at least one flow field channel.

21. An electrochemical cell component comprising a first coolant plate sealed to an adjacent plate using the process of any one of claim 1 to 20.

22. An electrochemical cell comprising a first coolant plate and an adjacent plate, wherein the first coolant plate is sealed to the adjacent plate using the process of any one of claims 1 to 20.

23. An electrochemical cell comprising the fuel cell component of claim 21.

24. An electrochemical cell stack comprising a plurality of the electrochemical cells of claims 22 or 23.

25. The cell component of claim 21, wherein the cell component has a contact resistance less than the contact resistance of two plates that are not joined together.

26. The cell component of claim 21 or 25, wherein the cell component has a contact resistance that is independent of compression pressure applied to the cell component.
